(19) United States
(12) Patent Application Publication
(10) Pub. No.: US 2019/0240942 A1
(43) Pub. Date: Aug. 8, 2019

(54) CUTTING AND EJECTION METHOD FOR A CARDBOARD BLANK AND EJECTION STRIP FOR SUCH A METHOD

(71) Applicant: LAGORA, LUXEMBOURG (LU)

(72) Inventors: Nicolas MEYER, Allan (FR); Serge CROUZET, Chatel Saint Denis (CH)

(21) Appl. No.: 16/329,314

(22) PCT Filed: Aug. 25, 2017
(86) PCT No.: PCT/EP2017/071426

§ 371 Date: Feb. 28, 2019

(30) Foreign Application Priority Data
Sep. 9, 2016 (LU) 93201

(51) Int. Cl. B31B 50/20; B31B 50/83

(52) U.S. Cl. CPC B31B 50/20; B26F 1/40; B31B 50/83

(57) ABSTRACT

The invention provides a method of cutting out an opening in a flat cardboard blank (10, 12) that is for use in manufacturing a package, wherein a first portion (18) of the blank (10, 12) and an ejector tape (34) that face each other are pressed together between a presser tool (24) and an activation tool (26) that face each other so as to cause the ejector tape (34) to stick exclusively on the first portion (18) of the blank (10, 12). The invention also provides an ejector tape for such a method.

The invention relates to the field of packages obtained from a sheet of cardboard.

Such packages are obtained by cutting blanks out of a sheet of cardboard, each blank then being folded along fold lines to form a three-dimensional package or package element. The cardboard used for such packages generally presents weight lying in the range 180 grams per square meter (g/m²) to 2000 g/m², and nevertheless more usually in the range 220 g/m² to 350 g/m².

For reasons that may be utilitarian or esthetic, such packages are sometimes provided with one or more openings or windows formed in the sheet of cardboard. These openings, which are characterized by a closed outline, may be complex in shape, and may for example form a pattern, such as a letter or a portion of a letter. Thus, under such circumstances, these openings may present, in at least one direction, at least one dimension that is very small, less than 5 millimeters (mm), or indeed less than 3 mm between two opposite edges of the opening.

It is known to make openings by forming a closed-loop cutout line in the piece of cardboard, before or after cutting out the blank, the cut-out outline defining a first portion of the blank relative to a second portion of the blank situated outside the cutout line. Such a cutout be made by various means. Under all circumstances, it is generally necessary to provide specific means for ejecting the portion of the piece of cardboard that corresponds to the opening, i.e. for separating this portion from the remainder of the sheet. In the state of the art, this is generally done by needle devices that push mechanically against the portion for ejecting.

Nevertheless, present techniques do not make it possible under economically acceptable conditions to obtain openings of very small size, in particular presenting at least one dimension that is less than 5 mm, or even less than 3 mm.

Specifically, the packages under consideration are generally produced at a high rate, and thus on high-speed machines along which the sheets of cardboard move quickly. It is therefore difficult in particular to guarantee that the sheet is positioned very accurately along its path through the machines. As a result, since the sheet is not accurately positioned, it is not possible to use needle systems since they might then strike against the sheet outside the opening.

Document JP 2016/30318 describes a method of using a tape of heat-sensitive adhesive applied to a laminate comprising a base layer and an adhesive layer.

The steps of cutting out and activating the adhesive with heat take place simultaneously. The cutting-out and activation tool does not make provision for offset activation by a radial margin.

Document JPH 04/170489 describes an adhesive tape.

An object of the invention is to propose a method of manufacture that enables an opening to be made in a flat cardboard blank, including an opening that has at least one dimension of less than 5 mm, or even less than 3 mm, with reliability that is sufficient and at a cost that is economically acceptable in the context of mass-producing packaging, in particular using machines operating at more than one thousand strokes per hour, and thus manufacturing at least one thousand blanks per hour and per machine, or one thousand series of blanks arranged side by side in a sheet, per hour and per machine.

For this purpose, the invention provides a method of cutting out an opening in a flat cardboard blank for manufacturing a package, the blank having a first face and an opposite second face.

The method comprises:
forming a closed-loop cutout line in the cardboard blank, the cutout line defining a first portion of the blank and a second portion of the blank outside the cutout line;
bringing the first face of the blank to face an ejector tape including an adhesive layer, the ejector tape being arranged with its adhesive layer on a side towards the first face of the blank and facing the first portion of the blank;
bringing the blank and the ejector tape to face each other between a presser tool and an activation tool that face each other;
the activation tool presenting a protruding active face facing towards the ejector tape and the blank, with its protruding portion being defined by a peripheral edge;
a projection of the peripheral edge perpendicularly onto a plane in which the blank extends being inscribed inside the cutout line with an activation radial margin towards the inside away from the cutout line;
inside the peripheral edge, the active face presenting a recess;
the presser tool presenting a boss projecting towards the blank from a peripheral surface facing towards the blank, the boss presenting an outline relative to the peripheral surface;
a projection of the outline of the boss perpendicularly onto the plane in which the blank extends being inscribed inside the projection of the peripheral edge of the activation tool perpendicularly onto said plane with a presser radial margin towards the inside; and
pressing together the first portion of the blank and the facing ejector tape between the presser tool and the facing activation tool in such a manner as to cause the ejector tape to stick exclusively to the first portion of the blank.

According to other characteristics of the invention that are optional:
The presser tool comes into contact with the second face of the blank preferably before the ejector tape is pressed against the first face of the blank by the activation tool.
The activation radial margin between the projection of the peripheral edge of the protruding portion of the active face of the activation tool and the cutout line is not less than 0.1 mm, preferably not less than 0.2 mm over the extent of the peripheral edge.
The presser radial margin between the perpendicular projections onto the plane in which the blank extends of the outline of the boss of the presser tool and of the peripheral edge of the protruding portion of the active face of the activation tool is preferably not less than 0.1 mm, more preferably not less than 0.2 mm over the extent of the peripheral edge.
The maximum depth of the recess in the active face of the activation tool lies preferably in the range 0.1 mm to 0.5 mm.
The maximum height of the boss relative to the peripheral surface of the presser tool is preferably greater than 0.5 mm.
The maximum height of the boss relative to the peripheral surface of the presser tool lies in the range 0.8 mm to 1.2 mm.
A resilient back-presser may be arranged relative to the presser tool on the opposite side of the assembly formed by the blank and the ejector tape.
The resilient back-presser is arranged preferably outside the perimeter of the cutout line defining the opening.
At least one of the activation tool and the presser tool may be heated, at least during the pressing step, to a temperature higher than 80° C., more preferably higher than 120° C.
The cutout line may be cut out in two successive steps comprising a first step of cutting out a first portion of the cutout line, and a second step of cutting out a second portion of the cutout line.
The two operations of cutting out the first and second portions of the cutout line may be performed by means of respective first and second cutters having respectively the shape of the first portion and the shape of the second portion of the cutout line.
The cutout line may be cut out in a single operation.
The cutout line preferably forms a continuous cut right through the thickness of the blank over the entire length of the cutout line.
The first portion of the blank is for example situated inside the closed-loop cutout line, and the second portion of the blank is situated outside the cutout line.
The flat blank may extend in a plane and it may be delivered flat in a machine movement direction parallel to the plane in which it extends between the facing presser tool and activation tool, and the pressing may be obtained by relative movement between the presser tool and the activation tool in translation in a direction perpendicular to the plane in which the blank extends.
The layer of adhesive of the ejector tape may comprise a heat-activatable adhesive.
The adhesive layer of the ejector tape may comprise a hot-melt adhesive based on EVA copolymers.
The ejector tape may comprise a support layer supporting the adhesive layer of the ejector tape.
The support layer of the ejector tape may comprise a layer of paper.
The ejector tape may present thickness lying in the range 0.05 mm to 0.3 mm, preferably in the range 0.1 mm to 0.15 mm.
After pressing the first portion of the blank and the ejector tape together between the presser tool and the activation tool, the ejector tape may be separated from the second portion of the blank, with the first portion of the blank thus being separated from the second portion of the blank by sticking to the activation tape.
The method may include making a plurality of opening cutouts that are offset from one another in a direction perpendicular to the movement direction of the machine, and may include using a plurality of distinct ejector tapes that are offset from one another in the direction perpendicular to the movement direction of the machine.
An ejector tape for a method of cutting out and ejecting an opening in a cardboard blank, the ejector tape comprising an adhesive layer supported by a support layer, the adhesive layer comprising a heat-activatable adhesive, e.g. a hot-melt adhesive based on ethylene vinyl acetate (EVA) copolymers. The support layer that supports the adhesive layer of the ejector tape may comprise a layer of paper, e.g. a layer of kraft paper. The ejector tape may present thickness lying in the range 0.05 mm to 0.3 mm, preferably in the range 0.1 mm to 0.15 mm.

Various other characteristics appear from the following description made with reference to the accompanying drawings which show embodiments of the invention and non-limiting examples.

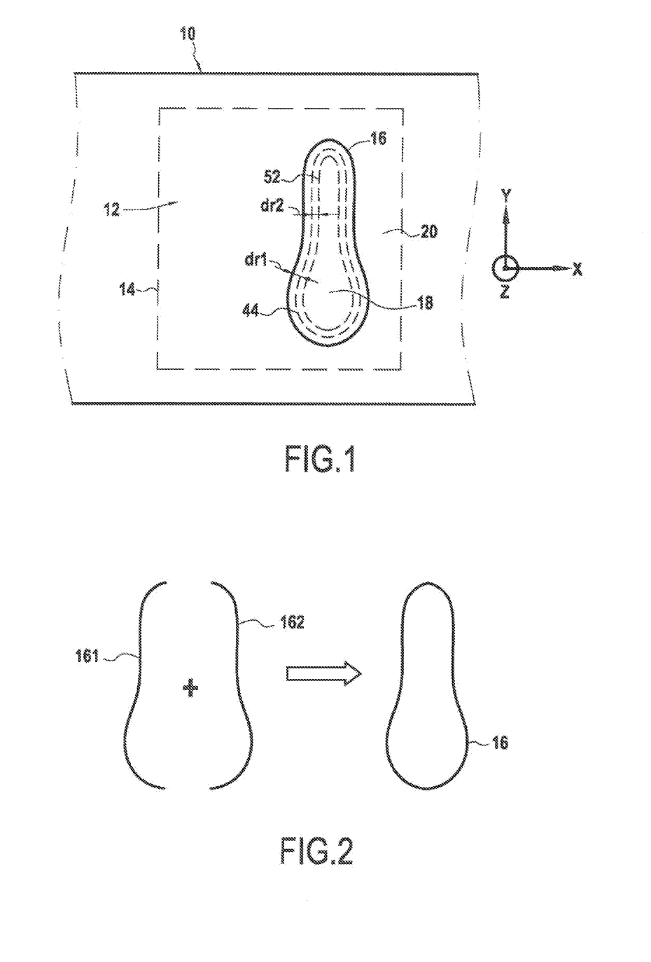

FIG. 1 is a diagram showing a sheet of cardboard in which there is defined a blank that includes an opening.

FIG. 2 shows a cutout line being made in two successive steps.

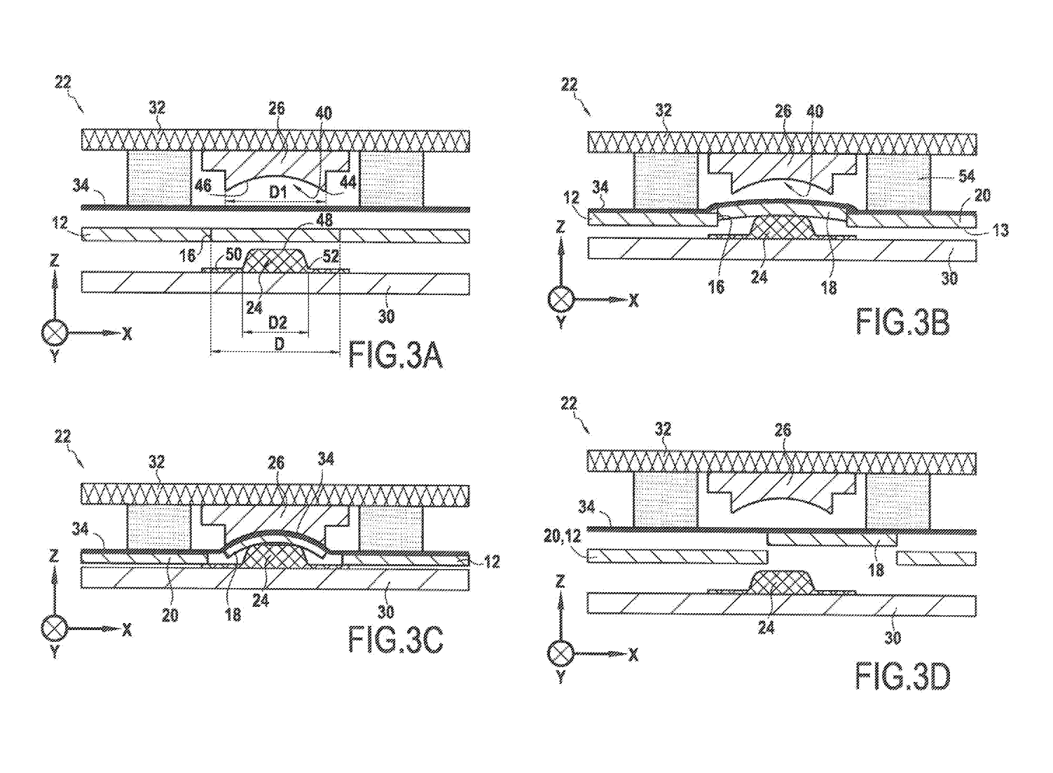

FIGS. 3A-3D show four successive steps in a method of the invention.

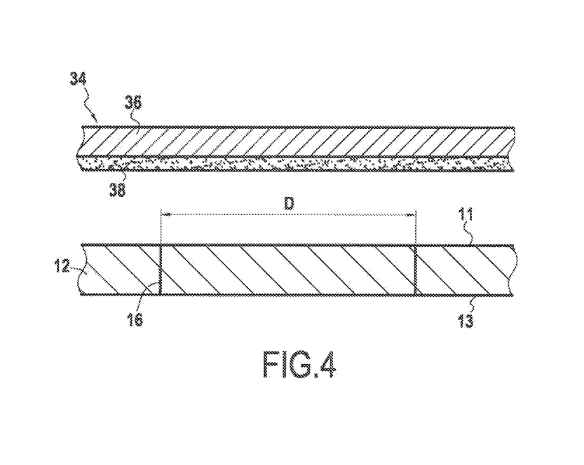

FIG. 4 is a diagrammatic section view of an ejector tape and a blank suitable for use in a method of the invention.

The invention applies to the field of cardboard packaging, e.g. cardboard packaging for foodstuffs or cardboard packaging for cigars or cigarettes, where the packages are produced in very large numbers. Nevertheless, the invention may also be applied to cardboard packaging for cosmetics.

The packages are manufactured by folding and assembling together one or more previously cut-out blanks. Each blank generally has fold lines previously scored therein. Each blank is cut out from a sheet of cardboard.

The invention seeks to provide a method of cutting out an opening in such a blank. The method may be performed in the blank before it is itself cut out from the sheet of cardboard, or on the contrary after the blank has been cut out from the sheet of cardboard.

The material of the blank is preferably a conventional material for this type of packaging. By way of example, it may be cardboard presenting weight that is greater than or equal to 180 g/m². Generally, the cardboard used for such packaging presents weight that is less than or equal to 2000 g/m². It has been found that weights lying in the range 220 g/m² to 350 g/m² are particularly advantageous.

FIG. 1 is a diagram showing a sheet of cardboard 10 in which it is possible to define a blank 12 that is to form a package. The blank 12 is a flat blank that extends in a plane defined in the figures by mutually perpendicular axes X and Y. In the example shown, the blank 12 has not yet been cut out. It may be defined in the sheet of cardboard 10 by a peripheral trace 14, however this peripheral trace could very well not exist physically on the sheet 10 and could be revealed only once the blank 12 has indeed been cut out from the sheet 10.

In the invention, the blank 12, and thus the sheet 10, presents a closed-loop cutout line 16 that defines the opening that is to be formed in the blank 12, and thus in the sheet 10.

The cutout 16 may be made in any manner known to the person skilled in the art. In certain implementations, it is made using one or more punches or cutters.

For example, as shown in FIG. 2, the closed-loop cutout line 16 may be cut out in two successive steps comprising a first step of cutting a first portion 161 of the closed-loop cutout line 16 and a second step of cutting a second portion 162 of the closed-loop cutout line 16. Under such circumstances, the two operations of cutting the first and second portions 161 and 162 of the cutout line 16 may be performed by respective first and second cutters respectively having the shape of the first portion and the shape of the second portion of the cutout line. Nevertheless, the closed-loop cutout line 16 could be cut out in a single operation, e.g. by means of a punch having a sharp portion that occupies the entire shape of the closed-loop cutout line 16.

In the blank 12, the cutout 16 thus defines a first portion 18 of the blank 12, e.g. situated inside the cutout 16, and a second portion 20 of the blank 12, which in this example is situated outside the cutout 16. In the example under consideration, the first portion 18 of the blank 12 is thus considered to be a clipping, while the second portion 20 forms an integral portion of the final package. Nevertheless, it is entirely possible to consider that the portion of interest is the inside portion and that the clipping is the outside portion of the cutout.

In the example shown, the cutout 16 may present any shape. Specifically, the opening shown as defined by the cutout 16 presents a transverse dimension D in the plane of the blank 12. For the entire cutout, the transverse dimension varies with position, but for the opening defined by the cutout 16 it is always possible to define a minimum transverse dimension of the opening between two opposite points of the cutout where two opposite edges of the opening come closest together.

The closed-loop cutout line 16 is preferably cut out in one or more operations using a sharp tool, with the sharp tool contacting the blank. Preferably the edge of the blade of the sharp tool is narrow so as to provide a cut that is clean and leaves no trace. A known drawback of such sharp tools, in particular those in which the edge of the blade is narrow, lies in the clipping, not necessarily dropping away on its own under gravity when the cardboard is cut, i.e. in this example the first portion 18 of the blank 12 does not necessarily drop away.

The closed-loop cutout line 16 preferably forms a continuous cut right through the thickness of the blank 12 over the entire length of the cutout line 16. Nevertheless, even under such circumstances, it commonly happens, after the cutting-out operation, that the inside portion 18 of the blank defined by the cutout 16 remains wedged via its edges at its location in the center of the opening, and in the same plane as the outside portion 20 of the blank.

Thus, in a step subsequent to the step of cutting out the cutout line 16, the invention provides for an ejection operation during which the first portion 18 and the second portion 20 of the blank 12 are separated from each other. In the example shown, it is more particularly the first portion 18 that is removed by being extracted from the plane in which the second portion 20 of the blank 12 extends.

Naturally, these operations are advantageous automated and performed on a production line, e.g. comprising a cutter station (not shown) followed by an ejector station 22 as shown diagrammatically in FIGS. 3A to 3D. It is assumed herein that the blank 12, specifically the sheet of cardboard 10, is delivered flat, in a movement direction of the machine parallel to the plane in which it extends, specifically the longitudinal direction X.

By way of example, in order to simplify the description, it is considered that the plane defined by the directions X and Y is horizontal, but that should not be understood as being a limit on the invention insofar as it is possible to provide for the blank 12 to have some other orientation for the ejection operation. Specifically, the blank 12 presents a first face 11, which may arbitrarily be referred to as its “top” face with reference to the figures and an opposite, second face 13, which may thus arbitrarily be referred to as its “bottom” face.

The blank 12, specifically the sheet of cardboard 10, may thus be transported in this X, Y plane, e.g. by means of gripper clamps gripping the longitudinal edges of the sheet of cardboard 10.

In the example shown, ejection is performed specifically by means of a presser tool 24 and of an activation tool 26 that, in this example, are incorporated in the ejector station 22. The presser tool 24 and the activation tool 26 face each other. Means are provided for causing the presser tool 24 and the activation tool 26 to move relative to each other in translation in a direction Z that is perpendicular to the X, Y plane of the blank 12.

In the example shown, the ejector station 22 has a bottom plate 30 and a top plate 32, both of which are parallel to the plane in which the blank 12 extends, and are thus horizontal. An actuator mechanism (not shown), e.g. comprising an electrical, pneumatic, or hydraulic actuator, possibly associated with a transmission mechanism, serves to move the two plates 30 and 32 relative to each other in a direction perpendicular to the X, Y plane of the blank 12, and thus in the direction Z, which is considered by convention in this example to be vertical. The bottom plate 30 presents a top face on which it is possible to secure the presser tool 24, and the top plate 32 presents a bottom face on which it is possible to secure the activation tool 26, these two tools 24 and 26 being arranged to face each other and being brought towards each other by the plates 30 and 32 so as to perform an operation of pressing an ejector tape 34 against the blank 12, as described below.

Specifically, the cutting-out and ejection method of the invention makes use of an ejector tape 34. This ejector tape is for presenting parallel to the blank 12, i.e. in a plane parallel to the X, Y plane of the blank 12. As shown in FIG. 4, the ejector tape 34 has a layer of adhesive 38 that is supported by a support layer 36 in this embodiment.

By way of example, the adhesive layer 38 of the ejector tape 34 is a activatable adhesive, e.g. e.g. a heat-activatable adhesive. In known manner, in order to adhere to a surface, such an adhesive needs to be raised to a temperature higher than an activation temperature. Below its activation temperature, its adhesive power on being put into contact with a surface is very limited or even zero. In contrast, above its activation temperature, it adheres to the surface and this adhesion is subsequently conserved even when the temperature of the adhesive drops below the activation temperature. Such a heat-activatable adhesive may comprise a hot-melt adhesive based on EVA copolymers. By way of example, the inventors have performed the invention successfully while using an ejector tape comprising a layer of adhesive constituted by a layer of adhesive sold by the supplier Henkel Technologies France, 161 rue de Silly, F-92100 Boulogne Billancourt, France, under the reference “Technomelt Q 3656 FR”. Such adhesives generally present an activation temperature lying in the range 80° C. to 120° C. Nevertheless, other adhesives may be used, in particular other activatable adhesives. Depending on the application, the adhesive may be selected to have an activation temperature that is higher or lower.

In a variant, instead of a heat-activatable adhesive, it is possible to use a pressure-activatable adhesive.

The ejector tape may include 10 g/m² to 50 g/m² of adhesive, preferably 15 g/m² to 35 g/m², more preferably 20 g/m² to 25 g/m².

In the example shown, the ejector tape 34 has a support layer 36 that supports the adhesive layer 38 of the ejector tape. Such a support layer 36 makes the ejector tape easier to handle and makes the method easier to perform. For example, the support layer 36 of the ejector tape 34 may comprise a layer of paper. The inventors have performed the invention successfully with the support layer 36 made specifically from a layer of kraft paper, e.g. a machine-glazed natural kraft paper sold by the supplier Gascogne Paper, Quartier de Bel Air, 40200 Mimizan, France, under the reference “086-Adour® 2000”, in its version weighing 90 g/m². Nevertheless, other types of paper could be used. Likewise, a support layer 36 could be made of or could include other materials. For example, it is possible to envisaging making the support layer 36 for the ejector tape 34 out of a polymer material, e.g. a polyethylene terephthalate (PET).

In the example shown, the ejector tape 34 presents thickness lying in the range 0.05 mm to 0.3 mm, e.g. in the range 0.1 mm to 0.15 mm.

The ejector tape 34 is arranged so as to be presented with its adhesive layer 38 on a side towards the first face 11 of the blank 12 and facing the first portion 18 of the blank 12.

For the ejection operation, the ejector tape 34 is fed continuously over the sheet of cardboard 10, and thus over the blank 12. This thus takes place after the cutout line 16 has been cut. The ejector tape 34 may be in the form of a reel that is unreeled and guided so as to be brought into position in the ejector station 22 above the first portion 18 of the blank 12 that is to be ejected.

Thus, the blank 12 with its cutout line 16 and the ejector tape 34 are caused to face each other between the presser tool 24 and the activation tool 26, which themselves face each other in the direction perpendicular to the X, Y plane of the blank 12.

As can be seen in FIGS. 3A to 3D, the activation tool 26 has an active face 40 that projects from a base 42. In the example shown, the base 42 forms an integral portion of the activation tool 26 and serves as an interface with the top face 32. Nevertheless, the base 42 could be a separate part, or indeed it could be constituted by the top face 32. The active face 40 of the activation tool 26 faces towards the ejector tape 34 and the blank 12. Its protruding portion is defined by a peripheral edge 44 that, when projected perpendicularly onto the plane of the blank, is itself inscribed within the closed-loop cutout line 16, with an activation radial margin “dr1” towards the inside away from the cutout line 16 defining the opening. The activation radial margin dr1, between the projection of the peripheral edge 44 of the protruding portion of the active face 40 of the activation tool 26 and the closed-loop cutout line 16 is preferably at least 0.1 mm, more preferably at least 0.2 mm over the extent of the peripheral edge.

Inside the peripheral edge 44, the active face 40 presents a recess 46. This recess forms a concave region in the active face 40 set back from the peripheral edge 44. The depth of this recess 46 relative to the peripheral edge 44 in a direction perpendicular to the plane of the blank 12 preferably lies in the range 0.1 mm to 0.5 mm. In an embodiment, for a cardboard blank 12 presenting thickness lying in the range 0.2 mm to 0.4 mm, e.g. of about 0.3 mm, the recess 46 may thus present a depth lying in the range 0.1 mm to 0.3 mm, e.g. 0.2 mm relative to the peripheral edge 44.

The active face 40 of the activation tool 26 is for pressing the ejector tape 34 against the first face 11 of the first portion 18 of the blank 12.

The active face 40, defined by its peripheral edge 44, is thus inscribed within the cutout 16 when projected perpendicularly onto the plane of the blank 12. FIG. 3A is a section view on a plane perpendicular to the plane of the blank, and it shows the dimension D1 between two opposite points in this section of the peripheral edge 44 of the active face 40, which dimension is less than the dimension D between the two opposite points in this section of the opening that is defined by the closed-loop cutout line 16. Preferably, the active face 40 is centered relative to the opening, and as shown in FIG. 1, the activation radial margin dr1 is preferably constant all around the outline of the opening 16 and all around the active face 40. Under such circumstances, these dimensions are associated by the relationship:

D=D1+2×dr1

In embodiments in which an ejector tape is used that carries a heat-activatable adhesive, at least one of the activation tool 26 and the presser tool is, at least during the pressing step, heated to a temperature that is higher than the activation temperature of the adhesive, e.g. a temperature higher than 80° C., more preferably higher than 120° C. For example, the activation tool 26 includes heater means for heating the active face 40, or at least for heating a portion thereof, in particular its peripheral edge 44. By way of example, the heater means may be in the form of a resistance incorporated in or flush with the tool 26 or the top plate 32, with the plate and the tool then preferably being made out of materials that present good thermal conductivity, e.g. out of metal. By way of example, the activation tool 26 may be made of brass. The heater means may make use of induction heating. The heater means may comprise a circuit for passing a flow of hot fluid, that is incorporated in or flush with the activation tool 26 or the top plate 32. It is also possible to make provision for heater means that are indirect and external, serving to heat the active face 40 from the outside, e.g. by means of infrared heating or by using a stream of hot air.

In the method of the invention, the activation tool 26 co-operates with the presser tool 24 in order to press the ejector tape 24 against the blank 12.

The presser tool 24 presents a boss 48 extending towards the blank 12 relative to a peripheral surface 50 facing the blank. In the example shown, the peripheral surface 50 is the surface of a plane collar surrounding the boss, forming part of the presser tool 24, and forming an interface for fastening the tool 24 on the bottom plate 30. Nevertheless, the plane collar could be a part that is separate from the tool 24. In yet another variant, the peripheral surface 50 could be a surface element of the bottom plate 30.

The boss 48 of the presser tool 24 presents an outline 52 relative to the peripheral surface 50. A projection of the outline 52 of the boss 48 perpendicularly onto the plane of the blank 12 is inscribed within the projection of the peripheral edge 44 of the activation tool 26 perpendicularly onto that plane, with an inward presser radial margin “dr2”. The presser radial margin dr2 between the perpendicular projections onto the plane of the blank both of the outline 52 of the boss 48 of the presser tool 24 and also of the peripheral edge 44 of the protruding portion of the active face 40 of the activation tool 26 is preferably not less than 0.1 mm, more preferably not less than 0.2 mm over the extent of the peripheral edge 44. In the example shown, the outline 52 is a bottom outline defined at the bottom of the boss 48 where it joins the peripheral surface 50. In any event, the above relationships below are satisfied if consideration is given to the top outline of the boss that corresponds to the peripheral edge of the top surface of the boss that actually makes contact with the blank 12. In the example shown, this surface is plane.

FIG. 3A is in section on a plane perpendicular to the plane of the blank and shows the dimension D2 that lies, in a section, between the two opposite points of the outline 52 of the boss 48 of the presser tool is less than the dimension D1 that, in the same section, lies between the two opposite points of the peripheral edge 44 of the active face 40 of the activation tool 26. The boss 48 is preferably centered relative to the active face 40, and as shown in FIG. 1, the activation radial margin “dr2” is preferably constant all around the outline of the boss 48 and of the active face 40. Under such circumstances, these dimensions are associated by the relationship:

D1=D2+2×dr2

In the example shown, the outline 52 is a bottom outline defined at the bottom of the boss 48 where it joins the peripheral surface 50. In any event, the relationships below are satisfied if consideration is given to the top outline of the boss that corresponds to the peripheral edge of the top surface of the boss that actually makes contact with the blank 12. In the example shown, this top surface is plane, however it could be rounded.

The maximum height of the boss 48 relative to the peripheral structure 50 of the presser tool 24 is preferably greater than 0.5 mm. Specifically, below that height, it is found that ejection of the first portion 18 of the blank 12 is not necessarily ensured completely, and in particular there is a risk of the cardboard delaminating. In an embodiment in which the cardboard blank 12 presents thickness lying in the range 0.2 mm to 0.4 mm, e.g. about 0.3 mm, the maximum height of the boss 48 relative to the peripheral surface 50 of the presser tool 24 may for example lie in the range 0.8 mm to 1.2 mm, and in particular may be about 1 mm.

In the method, the first portion 18 of the blank 12 and the ejector tape 34 facing each other between the presser tool 24 and the activation tool 26, which also face each other, are pressed together so as to cause the ejector tape 34 to bond adhesively against the first portion 18 of the blank 12.

This is ensured in particular by the fact that the presser and activation tools 24 and 26 are of dimensions that ensure that their respective active surfaces that come into contact respectively with the bottom, second face 13 of the blank 12 and with the ejector tape 34 are both of smaller dimensions than the opening defined by the cutout line 16, and thus of smaller dimensions than the first portion 18 of the blank 12. Thus, activating the adhesive, whether by pressure or by heat or by a combination of both, takes place only within the outline of the active face 40 of the activation tool, and thus only in contact with the first portion 18 of the blank 12.

As shown in FIG. 3B, it is preferable to ensure that the presser tool 24 comes into contact with the second face 13 of the blank 12 before the ejector tape 34 is pressed against the first face 11 of the blank by the activation tool 26. This is ensured by controlling the relative movement between the presser tool 24, the activation tool 26, and the blank 12. In the example shown, and in a first stage of the pressing step, the relative movement is thus provided by relative movement between the tool 24 and the blank 12. It can be seen that this is done by moving the bottom plate 30 in translation towards the blank 12 in the direction perpendicular to the plane of the blank 12, while the blank 12 and the top plate 32 remain stationary. Nevertheless, the same relative movement could be obtained in other ways, e.g. by moving the blank towards the presser tool.

When the presser tool 24 comes into contact with the second face 13 of the first portion 18 of the blank 12, it begins to lift this first portion 18 relative to the second portion 20 of the blank 12.

Still more preferably, and as shown in FIG. 3B, provision is made to ensure that this contact between the presser tool 24 and the second face 13 of the blank 12 takes place before the active face 40 of the activation tool 26 comes into contact with the ejector tape 34. In particular, a resilient back-presser 54 may be provided that is arranged relative to the presser tool 24 on the side opposite from the assembly constituted by the blank 12 and the ejector tape 34, and thus on a side towards the activation tool 26. This resilient back-presser 54 is preferably arranged in such a manner as to be situated outside the perimeter of the closed-loop cutout line 16 that defines the opening, and thus radially on the outside around the active face 40 of the activation tool 26. This resilient back-presser 54 may be carried by the top plate 32, or by some other portion of the ejector station 22. This resilient back-presser 54 is arranged to come into contact with the assembly formed by the blank 12 and the ejector tape 34 before this assembly is pressed between the activation tool and the presser tool 24. Thus, in a rest state of the resilient back-presser 54, the active face 40 of the activation tool 26 is set back, since it is further away from the blank 12 than a bottom face of the resilient back-presser 54.

It can be seen that with such a provision, the resilient back-presser 54 also tends to press the ejector tape 34 against the first face 11 of the blank 12, still outside the perimeter of the opening defined by the closed-loop cutout line 16.

The resilient back-presser 54 may be arranged to extend all around the activation tool 26 in continuous manner. However the resilient back-presser could equally well be arranged in the form of individual elements that are distributed around the activation tool 26.

By way of example, the resilient back-presser 54 may be in the form of a ring or of studs of cellular material, e.g. of foam, in particular a polymer foam, or in the form of a ring or studs that are rigid and mounted on a spring.

The resilient back-presser 54 is preferably made at least in part out of a thermally insulating material, in particular a material having thermal conductivity of less than 1 watt per meter and per kelvin (Wm⁻¹K⁻¹).

FIG. 3C shows the moment when the first portion 18 of the blank 12 and the corresponding portion of the ejector tape 34 are pressed together between the presser tool 24 and the activation tool 26. This provides close contact between the tape 34 and the first portion 18 of the blank 12. Furthermore, where appropriate, contact between the tape 34 and the activation tool 26 serves to activate the adhesive of the ejector tape 34. This ensures sufficient adhesion between the ejector tape 34 and the first portion of the blank 12. In contrast, any contact that might be made between the tape 34 and the second portion 20 of the blank 12 outside the closed-loop cutout line 16, takes place with pressure and/or temperature that are not sufficient to enable the ejector tape 34 to adhere to the second portion 20.

Furthermore, the recess in the active face 40 of the activation tool 26, combined with the fact that the boss 48 of the presser tool 24 is smaller than the active face 40 since the projection of the outline 52 is inscribed inside the projection of the peripheral edge 44 of the active face 40, as explained above, tends to deform the first portion 18 of the blank 12 which becomes pressed between the two tools 24 and 26. This dome-shaped deformation tends to move the edges of the first portion 18 of the blank 12 away from the edges of the second portion 20 of the blank 12, thereby tending to separate the two portions 18 and 20 from each other.

As shown in FIG. 3D, after pressing the first portion 18 of the blank 12 against the ejector tape 34 between the presser tool 24 and the activation tool 26, the ejector tape 34 is separated from the second portion 20 of the blank 12. This separation is made possible in particular by the lack of adhesion between the ejector tape 34 and this second portion 20 of the blank 12. In contrast, by moving the ejector tape 34 away from the blank 12, the first portion 10 of the blank 12 is separated from the second portion 20 of the blank 12 since it remains stuck to the activation tape 34.

This separation takes place after the presser tool 24 has been moved away from the activation tool 26. This separation may take place when the two tools are moved apart or while or after moving the tape and the blank 12 relative to the tool in the longitudinal direction X.

This example shows a single cutout being made and the portion of the blank that corresponds thereto being ejected. In the event of a plurality of cutouts being made that are offset from one another in a direction perpendicular to the movement direction X of the machine, provision may be made to use a plurality of distinct ejector tapes that are offset from one another in the direction perpendicular to the movement direction of the machine, each tape being associated with a presser tool 24 and an activation tool 26 arranged in corresponding manner.

The invention is not limited to the embodiments described and shown, since various modifications may be made thereto without going beyond its ambit.

1. A method of cutting out an opening in a flat cardboard blank (10, 12) for manufacturing a package, the blank having a first face (11) and an opposite second face (13), the method comprising:
forming a closed-loop cutout line (16) in the cardboard blank (10, 12), the cutout line (16) defining a first portion (18) of the blank (10, 12) and a second portion (20) of the blank (10, 12) outside the cutout line (16);
bringing the first face (11) of the blank (10, 12) to face an ejector tape (34) including an adhesive layer (38), the ejector tape (34) being arranged with its adhesive layer (38) on a side towards the first face (11) of the blank (10, 12) and facing the first portion (18) of the blank (10, 12);
bringing the blank (10, 12), with its cutout line (16), and the ejector tape (34) to face each other between a presser tool (24) and an activation tool (26) that face each other;
the activation tool (26) presenting a protruding active face (40) facing towards the ejector tape (34) and the blank (10, 12), with its protruding portion being defined by a peripheral edge (44);
a projection of the peripheral edge (44) perpendicularly onto a plane in which the blank (10, 12) extends being inscribed inside the cutout line (16) with an activation radial margin (dr1) towards the inside away from the cutout line (16);
inside the peripheral edge (44), the active face (40) presenting a recess (46);
the presser tool (24) presenting a boss (48) projecting towards the blank (10, 12) from a peripheral surface (50) facing towards the blank (10, 12), the boss (48) presenting an outline (52) relative to the peripheral surface (50);
a projection of the outline (52) of the boss (48) perpendicularly onto the plane in which the blank (10, 12) extends being inscribed inside the projection of the peripheral edge (44) of the activation tool (26) perpendicularly onto said plane with a pressing radial margin (dr2) towards the inside; and
pressing together the first portion (18) of the blank (10, 12) and the facing ejector tape (34) between the presser tool (24) and the facing activation tool (26) in such a manner as to cause the ejector tape (34) to stick exclusively to the first portion (18) of the blank (10, 12).

2. A method according to claim 1, characterized in that the presser tool (24) comes into contact with the second face (13) of the blank (10, 12) before the ejector tape (34) is pressed against the first face (11) of the blank by the activation tool (26).

3. A method according to claim 1, characterized in that the activation radial margin (dr1) between the projection of the peripheral edge (44) of the protruding portion of the active face (40) of the activation tool (26) and the cutout line (16) is not less than 0.1 mm, preferably not less than 0.2 mm over the extent of the peripheral edge (44).

4. A method according to claim 1, characterized in that the pressing radial margin (dr2) between the perpendicular projections onto the plane in which the blank extends of the outline (52) of the boss (48) of the presser tool (24) and of the peripheral edge (44) of the protruding portion of the active face (40) of the activation tool (24) is not less than 0.1 mm, preferably not less than 0.2 mm over the extent of the peripheral edge (44).

5. A method according to claim 1, characterized in that the maximum depth of the recess (46) in the active face (40) of the activation tool (26) lies in the range 0.1 mm to 0.5 mm.

6. A method according to claim 1, characterized in that the maximum height of the boss (48) relative to the peripheral surface (50) of the presser tool (24) is greater than 0.5 mm.

7. A method according to claim 1, characterized in that the maximum height of the boss (48) relative to the peripheral surface (50) of the presser tool (24) lies in the range 0.8 mm to 1.2 mm.

8. A method according to claim 1, characterized in that a resilient back-presser (54) is arranged relative to the presser tool (24) on the opposite side of the assembly formed by the blank (10, 12) and the ejector tape (34).

9. A method according to claim 8, characterized in that the resilient back-presser (54) is arranged outside the perimeter of the cutout line (16) defining the opening.

10. A method according to claim 1, characterized in that at least one of the activation tool (26) and the presser tool is heated, at least during the pressing step, to a temperature higher than 80° C., more preferably higher than 120°C.

11. A method according to claim 1, characterized in that the cutout line (16) is cut out in two successive steps comprising a first step of cutting out a first portion (161) of the cutout line (16), and a second step of cutting out a second portion (162) of the cutout line (16).

12. A method according to claim 11, characterized in that the two operations of cutting out the first and second portions of the cutout line are performed by means of respective first and second cutters having respectively the shape of the first portion (161) and the shape of the second portion (162) of the cutout line (16).

13. A method according to claim 1, characterized in that the cutout line (16) is cut out in a single operation.

14. A method according to claim 1, characterized in that the cutout line (16) forms a continuous cut right through the thickness of the blank (10, 12) over the entire length of the cutout line (16).

15. A method according to claim 1, characterized in that the first portion (18) of the blank (10, 12) is situated inside the closed-loop cutout line (16), and the second portion (20) of the blank is situated outside the cutout line (16).

16. A method according to claim 1, characterized in that the flat blank extends in a plane (X, Y), in that it is delivered flat in a machine movement direction parallel to the plane in which it extends between the facing presser tool (24) and activation tool (26), and in that the pressing is obtained by relative movement between the presser tool (24) and the activation tool (26) in translation in a direction (Z) perpendicular to the plane in which the blank extends.

17. A method according to claim 1, characterized in that the layer of adhesive (38) of the ejector tape (34) comprises a heat-activatable adhesive.

18. A method according to claim 1, characterized in that the adhesive layer (38) of the ejector tape comprises a hot-melt adhesive based on EVA copolymers.

19. A method according to claim 1, characterized in that the ejector tape (34) comprises a support layer (36) supporting the adhesive layer (38) of the ejector tape (34).

20. A method according to claim 19, characterized in that the support layer (36) of the ejector tape (34) comprises a layer of paper.

21. A method according to claim 1, characterized in that the ejector tape (34) has a thickness lying in the range 0.05 mm to 0.3 mm, preferably in the range 0.1 mm to 0.15 mm.

22. A method according to claim 1, characterized in that, after pressing the first portion (18) of the blank (10, 12) and the ejector tape (34) together between the presser tool (24) and the activation tool (26), the ejector tape (34) is separated from the second portion (20) of the blank, with the first portion (18) of the blank thus being separated from the second portion (20) of the blank by sticking to the activation tape (34).

23. A method according to claim 1, characterized in that it includes making a plurality of opening cutouts that are offset from one another in a direction perpendicular to the movement direction of the machine, and in that it includes using a plurality of distinct ejector tapes that are offset from one another in the direction perpendicular to the movement direction of the machine.

24. An ejector tape for a method of cutting out and ejecting an opening in a cardboard blank, the ejector tape (34) comprising an adhesive layer (38) supported by a support layer (36), the tape being characterized in that the adhesive layer (38) comprises a heat-activatable adhesive.

25. An ejector tape according to claim 24, characterized in that the adhesive comprises a hot-melt adhesive based on EVA copolymers.

26. An ejector tape according to claim 24, characterized in that the support layer (36) that supports the adhesive layer (38) of the ejector tape comprises a layer of paper, e.g. a layer of kraft paper.

27. An ejector tape according to claim 24, characterized in that the ejector tape (34) has a thickness lying in the range 0.05 mm to 0.3 mm, preferably in the range 0.1 mm to 0.15 mm.
